(19) United States
(12) Patent Application Publication
(10) Pub. No.: US 2024/0133179 A1
(43) Pub. Date: Apr. 25, 2024

(54) JOIST AND NAILER ASSEMBLY HAVING NAILER PLATES AND A METHOD OF ASSEMBLING

(71) Applicant: NUCOR CORPORATION, Charlotte, NC (US)

(72) Inventors: Kaden Francis, Tremonton, UT (US); Colton Kilmer, Brigham City, UT (US)

(73) Assignee: NUCOR CORPORATION, Charlotte, NC (US)

(21) Appl. No.: 18/379,963

(22) Filed: Oct. 12, 2023

Related U.S. Application Data
(60) Provisional application No. 63/417,552, filed on Oct. 19, 2022.

(51) Int. Cl. E04C 3/29; F16B 15/00

(52) U.S. Cl. CPC E04C 3/291; F16B 15/0046

(57) ABSTRACT

Joists of a structural roofing system typically comprises an upper chord, a lower chord, and web(s), which operatively couple the upper chord to the lower chord. The upper chord and the lower chord may each be formed from two angle members (e.g., otherwise described as L-shaped members). The web may also be formed from a plurality of web members, such as angle members. The joists utilize nailer members on the upper chord to provide a location for assembly with decking panels. The nailer member is attached to the upper chord through the use of nailer plates, which have a plurality of perforated apertures that form teeth. The nailer plate is bent, the teeth are pressed into the nailer member, and plate connections are used to assemble the nailer plates (e.g., manually, automatically, or both) to the upper chord of the joist to form a joist and nailer assembly.

### PRIORITY CLAIM UNDER 35 U.S.C. § 119

This application claims priority to U.S. Provisional Application No. 63/417,552 entitled “An Open Web Joist and Nailer Assembly Having Nailer Plates and a Method of Assembling” filed on Oct. 19, 2022, which is assigned to the assignee hereof and the entirety of which is incorporated by reference herein.

### FIELD

This application relates generally to the field of joists, and in particular, joist and nailer assemblies in which a wooden, composite, or other nailer member is attached to a steel joist.

### BACKGROUND

Roof joist and decking systems are typically used in residential, commercial, or industrial construction. The roof joist and decking systems may utilize open web steel joist with a wooden nailer member attached to the upper chord of the open web steel joist so that sub-purlins and decking can be connected to the open web steel joist using standard nailing techniques. The connection of the wooden nailer member to the open web steel joist laterally supports the upper chord of the joist and transfers loads to the joist through the wooden nailer member.

### BRIEF SUMMARY

Joists of a structural decking system typically comprises an upper chord, a lower chord, and web(s), which operatively couple the upper chord to the lower chord. The web may be formed from a plurality of web members, one or more sheets of material with web apertures therein, or the like. The upper chord and the lower chord may each be formed from multiple portion, such as two angle members (e.g., otherwise described as L-shaped members, or the like). The web members may also be formed from angle members. The joists utilize nailer members on the upper chord to provide a location for assembly with decking panels. A nailer member may be attached to the upper chord through the use of nailer plates, which have a plurality of perforated apertures that form teeth. The nailer plate is bent, the teeth are pressed into the nailer member, and plate connections are used to attach the nailer plate (e.g., manually, automatically, or both) to the upper chord, as will be described herein in further detail. The frequency and size of the nailer plates are determined based on the engineered connection requirements between the upper chord and the nailer member.

One embodiment of the invention comprises a joist and nailer assembly. The joist and nailer assembly comprises an upper chord, a lower chord, a web operatively coupling the upper chord and the lower chord, a nailer member, and a plurality of nailer plates operatively coupling the nailer member to the upper chord using plate connections. The plurality of nailer plates extend around a portion of the upper chord and a side of the nailer member.

In further accord with embodiments, the upper chord comprises a first upper member, and a second upper member operatively coupled to the first upper member.

In other embodiments, the first upper member is operatively coupled to the second upper member through the web or a spacer.

In still other embodiments, the lower chord comprises a first lower member, and a second lower member operatively coupled to the first lower member.

In yet other embodiments, the first lower member is operatively coupled to the second lower member through the web or a spacer.

In other embodiments, the upper chord, the lower chord, or the web are formed from angle members.

In further accord with embodiments, the plurality of nailer plates comprise a nailer portion having a plurality of teeth. When assembled, the plurality of teeth extend into the nailer member.

In other embodiments, the nailer portion comprises a plurality of perforated apertures that form the plurality of teeth.

In still other embodiments the plurality of nailer plates comprise a chord portion. When assembled, the chord portion extends around a surface of the upper chord.

In yet other embodiments, the chord portion is operatively coupled to the surface of the upper chord through one or more plate connections.

In other embodiments, the one or more plate connections comprise fasteners.

In further accord with embodiments, the fasteners are self-drilling screws or powder pins.

In other embodiments, the one or more plate connections comprise a weld.

In still other embodiments, the weld is a toe weld on a toe of the chord portion of a nailer plate.

In yet other embodiments, the weld is a puddle weld or a spot weld within the chord portion of a nailer plate.

In other embodiments, the nailer member is wood.

Another embodiment of the invention comprises a nailer plate for use within a joist and nailer assembly. The nailer plate comprises a nailer portion having a plurality of teeth and a chord portion. When assembled, the plurality of teeth extend into a nailer member of the joist and nailer assembly, and the chord portion extends around a surface of an upper chord of the joist and nailer assembly.

In further accord with embodiments, the nailer portion comprises a plurality of perforated apertures that form the plurality of teeth.

Another embodiment of the invention comprises a method of forming a joist and nailer assembly. The method comprises assembling a plurality of nailer plates to a nailer member or an upper chord of a joist. The plurality of nailer plates comprise a nailer portion having a plurality of teeth and a chord portion. When the plurality of nailer plates are first assembled to the upper chord of the joist, the nailer portion is bent to press the plurality of teeth into the nailer member. Alternatively, when the plurality of nailer plates are first assembled to the nailer member, the chord portion is bent to a surface of the upper chord and operatively coupled to the upper chord using plate connections.

In further accord with embodiments, the bending is automated through the use of a bending means.

To the accomplishment of the foregoing and the related ends, the one or more embodiments of the invention comprise the features hereinafter fully described and particularly pointed out in the claims. The following description and the annexed drawings set forth certain illustrative features of the one or more embodiments. These features are indicative, however, of but a few of the various ways in which the principles of various embodiments may be employed, and this description is intended to include all such embodiments and their equivalents.

### BRIEF DESCRIPTION OF DRAWINGS

The accompanying drawings illustrate some of the embodiments of the invention and are not necessarily drawn to scale, wherein:

FIG. 1 illustrates a perspective view of a structural decking system that utilizes open web joist and nailer assemblies and attached roof assembly, in accordance with some embodiments of the present disclosure.

FIG. 2 illustrates an enlarged cross-sectional side view of a structural decking system utilizing open web joist and nailer assemblies, in accordance with some embodiments of the present disclosure.

FIG. 3A illustrates a perspective view of a joist without the nailer member, in accordance with some embodiments of the present disclosure.

FIG. 3B illustrates a side view of a joist without the nailer member, in accordance with some embodiments of the present disclosure.

FIG. 3C illustrates a top view or a bottom view of a joist that utilizes a plurality of web members for the connection between the upper chord and the lower chord, in accordance with embodiments of the present disclosure.

FIG. 3D illustrates a perspective view of a joist without the nailer member having a web made from a sheet, in accordance with some embodiments of the present disclosure.

FIG. 4A illustrates a perspective view of a nailer plate illustrating the teeth extending from the nailer plate, in accordance with some embodiments of the present disclosure.

FIG. 4B illustrates a perspective top view of a nailer plate illustrating the teeth extending from the nailer plate, in accordance with some embodiments of the present disclosure.

FIG. 4C illustrates a perspective side view of a nailer plate illustrating the teeth extending from the nailer plate, in accordance with some embodiments of the present disclosure.

FIG. 4D illustrates an enlarged view of the teeth of the nailer plate, in accordance with some embodiments of the present disclosure.

FIG. 4E illustrates a rear view of a nailer plate illustrating the apertures in the nailer plate, in accordance with some embodiments of the present disclosure.

FIG. 5A illustrates a perspective top view of a portion of an upper chord, a nailer member, and nailer plates, in accordance with some embodiments of the present disclosure.

FIG. 5B illustrates a perspective bottom view of a portion of an upper chord, a nailer member, and nailer plates, in accordance with some embodiments of the present disclosure.

FIG. 5C, illustrates a side view of a portion of an upper chord, a nailer member, and nailer plates, in accordance with some embodiments of the present disclosure.

FIG. 6A illustrates a cross-sectional view of an upper chord, a nailer member, and nailer plates utilizing self-drilling fasteners, in accordance with some embodiments of the present disclosure.

FIG. 6B illustrates a cross-sectional view of an upper chord, a nailer member, and nailer plates utilizing powder or air actuated pins, in accordance with some embodiments of the present disclosure.

FIG. 6C illustrates a cross-sectional view of an upper chord, a nailer member, and nailer plates utilizing a toe weld, in accordance with some embodiments of the present disclosure.

FIG. 6D illustrates a cross-sectional view of an upper chord, a nailer member, and nailer plates utilizing a spot weld or a puddle weld, in accordance with some embodiments of the present disclosure.

FIG. 7 illustrates a method of assembling joists with a nailer, in accordance with embodiments of the present disclosure.

### DETAILED DESCRIPTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

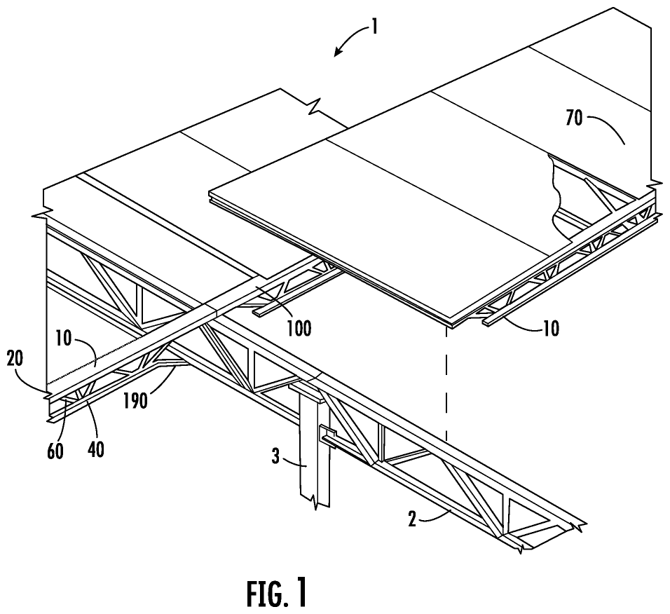

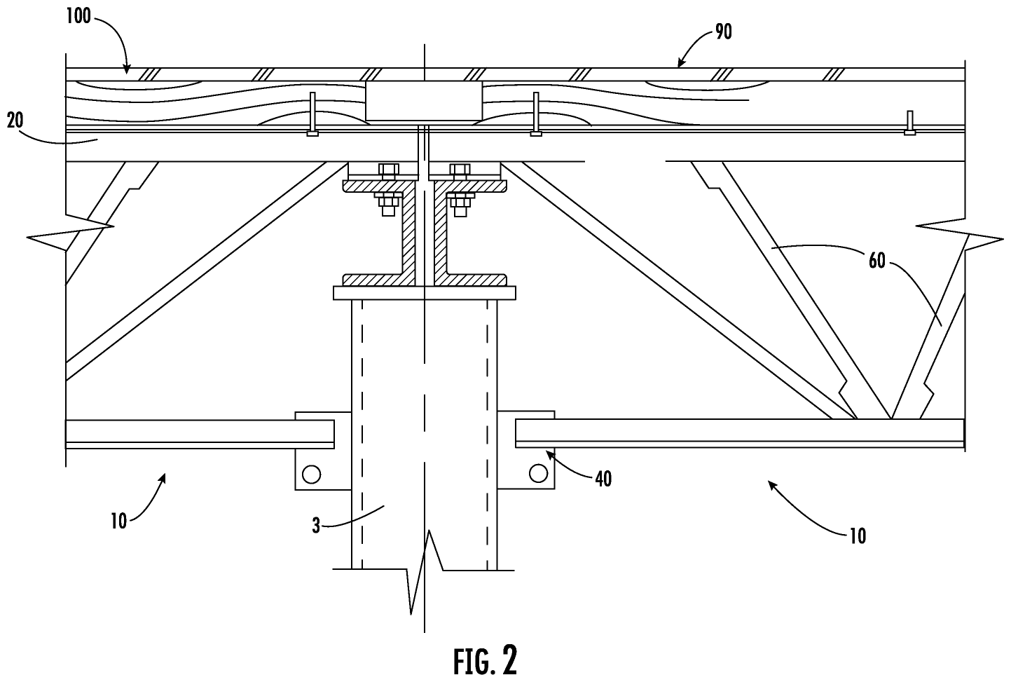

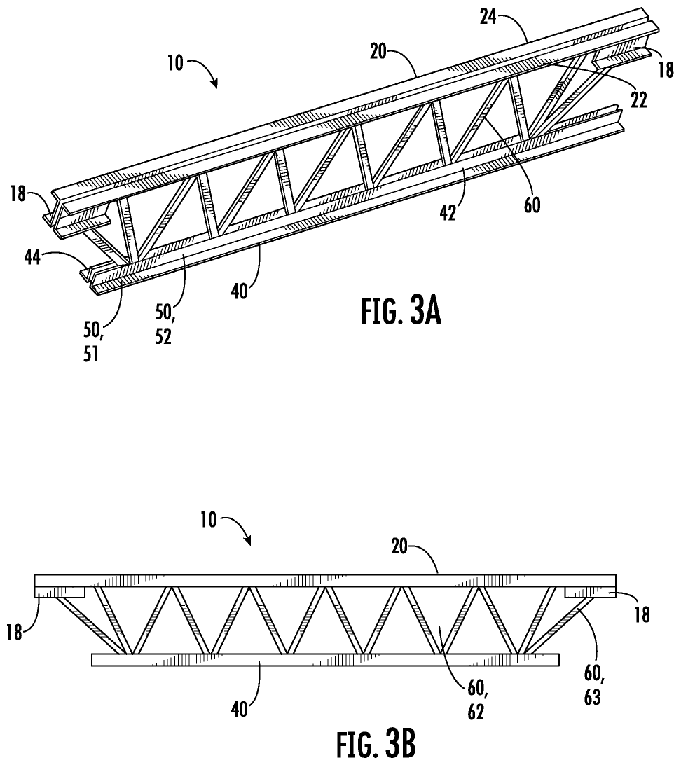

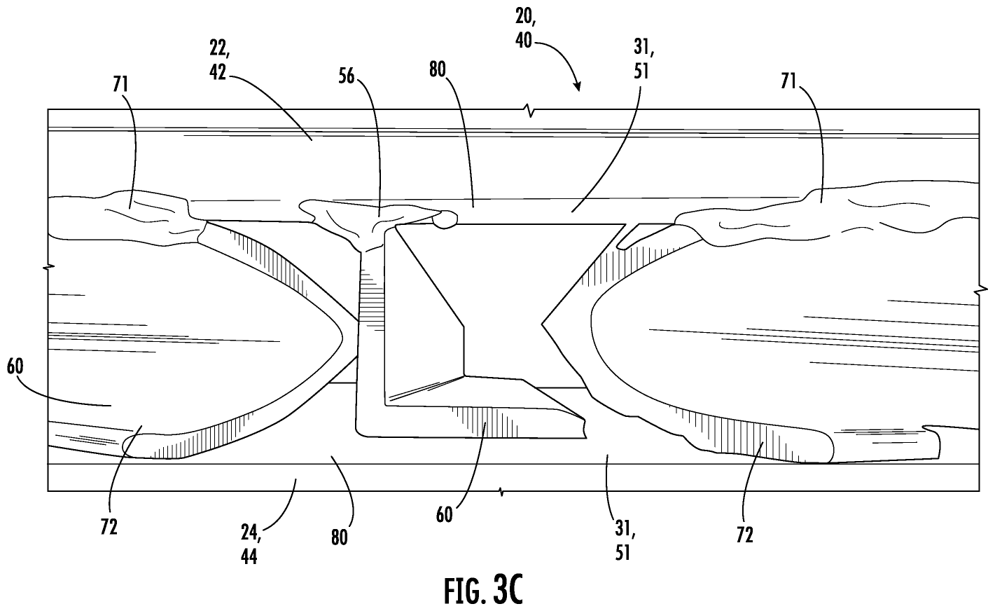

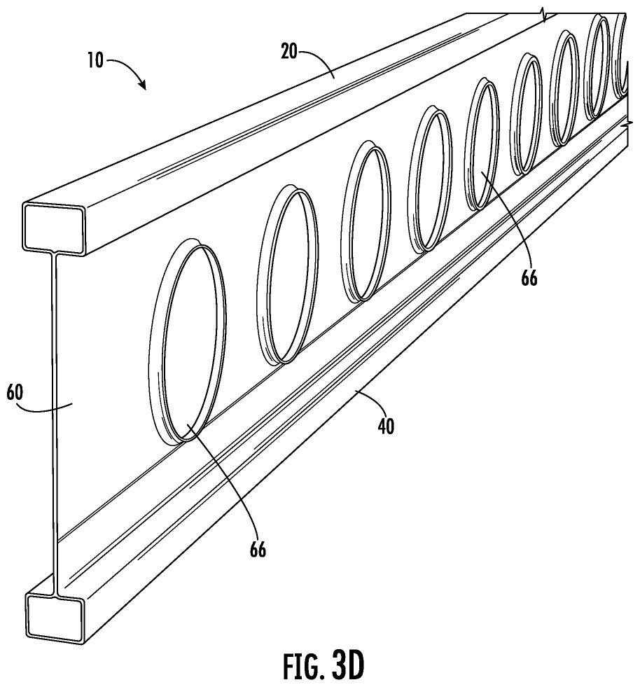

Structural decking systems 1 are used in residential, commercial or industrial construction. FIGS. 1 and 2 illustrate a structural roofing system 1 for a structure (e.g., building, or the like) comprising support members 3 (e.g., illustrated as a beam, but may be a wall, wall panel, concrete supports). The support members 3 may support girders 2, such as open web girder joists 2 as illustrated in FIG. 1. However, it should be understood that the girders 2 may be any type of support, such as a beam, wall, wall panel, or the like. The girders 2 may support joists with a nailer 10 (e.g., otherwise described as a joist and nailer assembly 10, or the like), such as open web joists with a nailer 12 (e.g., otherwise described as an open web joist and nailer assembly 12, or the like), as illustrated in FIG. 1. However, it should be understood that the joist and nailer assembly 10 may be any type of joist, such as a beam (e.g., cold-formed beam, or the like) as will be described with respect to FIG. 3D. Regardless of the type of joist and nailer assembly 10 utilized, the joist and nailer assembly 10 supports decking panels 90 that are operatively coupled to the nailer member 100 of the joist and nailer assembly 10. Moreover, the joists of the joist and nailer assembly 10 may comprise of an upper chord 20, a lower chord 40, and a web 60, which may be formed from one or more web members 62, a sheet 66 with sheet apertures 66. Regardless of the type of web 60, the web may be used to operatively couple the upper chord 20 and the lower chord 40, as will be described in further detail herein.

As illustrated in FIGS. 3A and 3B, in some embodiments, the upper chord 20 and the lower chord 40 comprise first members and second members operatively coupled together. For example, the upper chord 20 may comprise a first upper member 22 (e.g., a first upper angle member, or the like) operatively coupled to a second upper member 24 (e.g., a second upper angle member, or the like). In some embodiments, the first upper member 22 and the second upper member 24 are operatively coupled together through the use of a spacer (not illustrated). The spacer may be any type of spacer, such as a cylindrical, square, rectangular, angle, gusset, or other type of spacer that separates the first upper member 22 from the second upper member 24 to create a space between the first upper member 22 and the second upper member 24. As will be described herein, in some embodiments, the spacer is not necessary, and instead the web 60 spaces the first upper member 22 from the second upper member 24 during assembly, as will be described in further detail herein. In other embodiments, both the spacer and web 60 is used to create the space between the first upper member 22 and the second upper member 24. As previously discussed, the first upper member 22 and the second upper member 24 may be angle members, such as L-shaped members. As such, the first upper member 22 and the second upper member 24 may comprise arms 30 (e.g., proximal arms 31 and distal arms 32). The proximal arms 31 may each have inner surfaces 80 (e.g., proximal arm inner surface, or the like). The web 60 may be operatively coupled to the inner surface 80. The distal arms 32 may have top surfaces 81 (e.g., distal arm top surfaces), to which the nailer member 100 may be operatively coupled. The distal arms 32 may further comprise bottom surfaces 82 (e.g., distal arm bottom surfaces) to which the nailer plates 150 may be operatively coupled, as will be discussed in further detail herein. Furthermore, the proximal arms 31 may each have outer surfaces 83.

As further illustrated in FIGS. 3A and 3B, the lower chord 40 may comprise a first lower member 42 (e.g., a first lower angle member, or the like) operatively coupled to a second lower member 44 (e.g., a second lower angle member, or the like). In some embodiments, the first lower member 42 and the second lower member 44 are operatively coupled together through the use of a spacer (not illustrated). The spacer may be the same as the spacer previously described herein and used to separate the first lower member 42 from the second lower member 44 to create a space between the first lower member 42 and the second lower member 44. As will be described herein, in some embodiments, the spacer is not necessary, and instead the web 60 spaces the first lower member 42 from the second lower member 44 during assembly. In other embodiments, the both the spacer and web 60 are used to create the space between the first lower member 42 from the second lower member 44. As previously discussed, the first lower member 42 and the second lower member 44 may be angle members, such as L-shaped members. As such, the first lower member 42 and the second lower member 44 may comprise arms 50 (e.g., proximal arms 51 and distal arms 52). Like the upper chord 20, the lower chord 40 may have the same or similar surfaces. As such, the proximal arms 51 may each have inner surfaces 80 (e.g., proximal arm inner surface, or the like). The webs 60 may be operatively coupled to the inner surface 80. The distal arms 32 may have top surfaces 81 (e.g., distal arm top surfaces). The distal arms 32 may further comprise bottom surfaces 82 (e.g., distal arm bottom surfaces). Furthermore, the proximal arms 31 may each have outer surfaces 83.

While the upper chord 20 and lower chord 40 are illustrated as being formed from two L-shaped members, it should be understood that the upper chord 20 and lower chord 40 may be made of one or more members having any type of size, shape, and/or configuration. For example, the upper chord 20 and/or lower chord 40 may be made from one or more members that are c-shaped, u-shaped, w-shaped, v-shaped, n-shaped, m-shaped, or the like. Regardless of the shape of the upper chord 20, the upper chord 20 may have a surface around which the nailer plate 150 may be wrapped and/or operatively coupled.

The webs 60 may be any types of webs, such as one or more web members 62 may be angle members (e.g., like the chord members previously discussed), a bent continuous bar, separate bars, c-shaped webs, u-shaped webs, or any type of web member 62 having any shape. In the illustrated embodiments of FIGS. 1 through 3C, the one or more web members 62 (e.g., web angle members, or the like) are formed from angle members. The angle members, as illustrated in FIG. 3C, may have one or more arms 70 (e.g., a proximal arm 71 and a distal arm 72). The proximal arms 71 and/or distal arms 72 of the one or more web members 62 may have inner surfaces 74 and outer surfaces 75. The outer surfaces 75 of the web members 62 and/or a toe of the angle members may be operatively coupled to the inner surfaces 80 of the proximal arms 31, 51, of the upper chord 20 and/or the lower chord 40. Alternatively, or additional some of the web members 62 may be operatively coupled to the outer surfaces 83 of the proximal arms 31, 51 of the upper chord 20 and/or the lower chord 40, such as when a portion of the web angle member 62 is cut away (e.g., at the ends such that a surface-to-surface connection may be made with the one or more arms 70). In some embodiments, the web members 62 may be operatively coupled to a gusset member that is operatively coupled to the upper chord 20 and/or the lower chord 40 (e.g., a gusset plate welded to a surface 80, 83 of the proximal arms 31, 51 of the upper chord 20 and/or the lower chord 40). In some embodiments, the webs 60 may include an end web 63 that extends between a joist shoe 18 and the lower chord 40. The end web 63 may be the last web in in the joist 10. The joist shoe 18 may be any type of joist shoe, but in some embodiments the joist shoe 18 is operatively coupled to the upper chord 20. In some embodiments, the joist shoe 18 is directly operatively coupled to the proximal arms 31 of the upper chord 20 (as illustrated), or indirectly spaced above or below the upper chord 20, such as through web members 60 or other members (not illustrated).

In some embodiments, instead of being web members 62 formed between an upper chord 20 and/or a lower chord 40. The web 60 may be formed through the use of a sheet 64 that has one or more apertures 66 formed therein, as illustrated by the joist in FIG. 3D. It should be understood that the joist illustrated in FIG. 3D may be formed from a single sheet that is rolled into the upper chord 20, the lower chord 40 and/or the web 60 with one or more apertures 66 stamped (e.g., punched, or the like) into the web 60. Alternatively, the joist illustrated in FIG. 3D may be formed by rolling, bending, stamping, and/or the like the upper chord 20 and/or lower chord 40 apart from the web 60, and operatively coupling the web 60 to the upper chord 20 and/or lower chord 40 through the use of one or more connections 130 (e.g., fasteners 132, such as nails, screws, bolts, pins, nuts, or the like, clamps, other plates, welds, or the like). It should be understood that the sheet 64 may be made out of the steel; however, the sheet may be made of any metal, composite, or the like material.

The decking panels 90 of the structural panel system 1 may be operatively coupled to the joist and nailer assembly 10, such as to the nailer members 100 of the nailer joists 10 through the use of one or more panel connections (e.g., fasteners, such as nails, screws, bolts, pins, or the like, brackets, or the like). It should be understood that in some embodiments the panels 90 may be made of wood (e.g., solid wood, composite wood, plywood, oriented strand board (OSB), compressed wood, wood composites, layers thereof, or the like); however, it should be understood that panels 90 may be made of any type of material, such as steel, plastics, composites, or any other type of material.

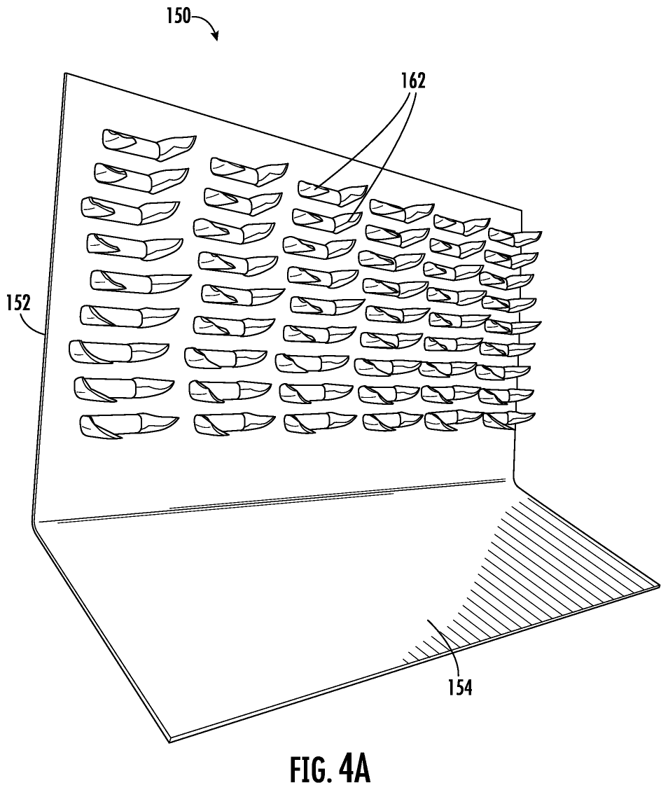

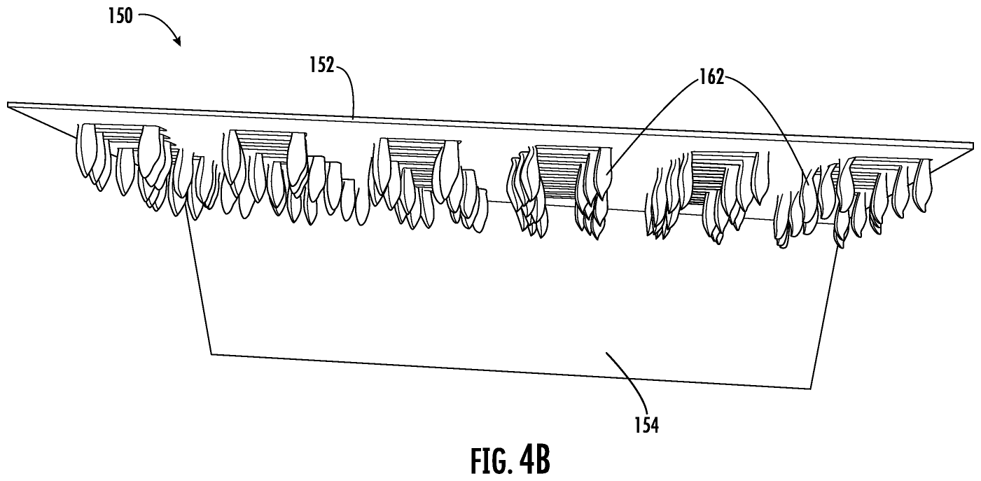

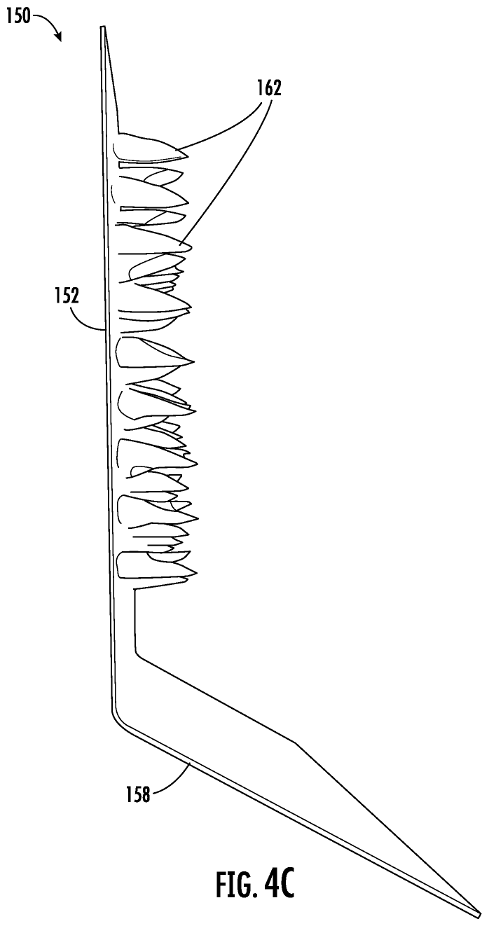

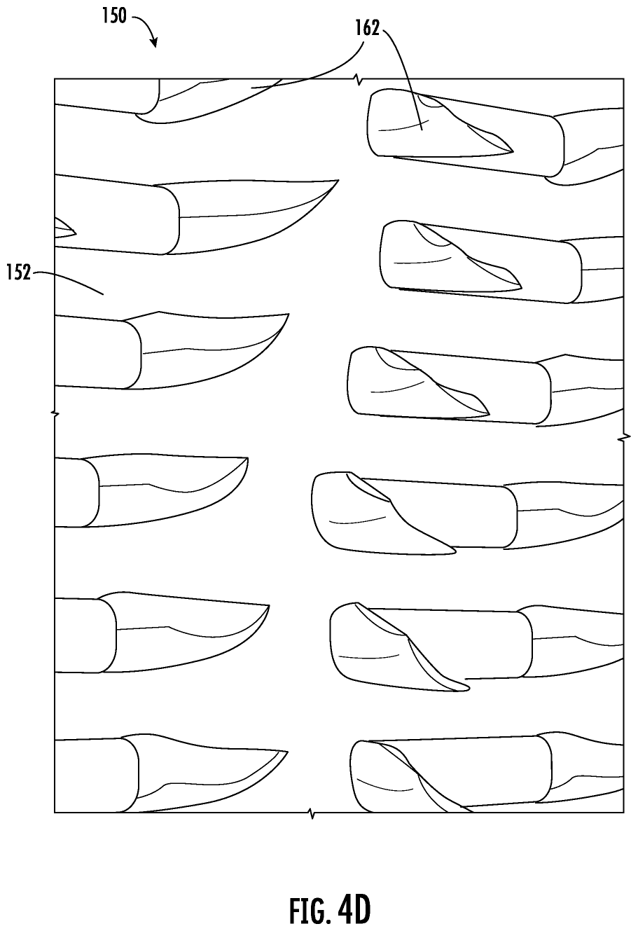

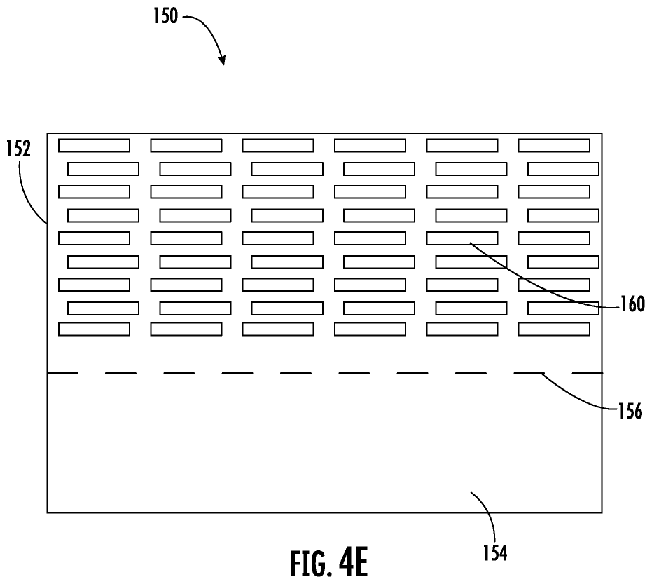

FIGS. 4A through 6D illustrate different embodiments of the nailer plate 150 and/or the installation of the nailer plate 150 to the nailer member 100. It should be understood that the nailer member 100 may comprise an upper surface 102, a lower surface 104, and two side surfaces 106, 107 and end surfaces 108, 109. Like the panels 90, the nailer member 100 is typically made of wood (e.g., solid wood, composite wood, plywood, Laminated Veneer Lumber, Laminated Strand Lumber, compressed wood, wood composites, layers thereof, and/or the like); however, it should be understood that the nailer member 100 may be made of any type of material, such as steel, plastics, composites, or any other type of material.

As illustrated in FIGS. 4A through 4E, the nailer plate 150 (e.g., otherwise described as a nailer bracket, a nailer strut, a nailer brace, press plate, or the like) may comprise a first portion 152 (e.g., nailer portion, nailer plate portion, or the like) and a second portion 154 (e.g., a chord portion, chord plate portion, or the like). The first portion 152 may comprise a plurality of apertures 160 and/or a plurality of teeth 162. In some embodiments, the plurality of teeth 162 are formed by creating the plurality of apertures 160. For example, punching out and bending material from the first portion 152 to form the plurality of teeth 162, which creates a plurality of perforation apertures 160. There may be any number of teeth 162 and/or perforation apertures 160. As such, there may be 2, 4, 5, 10, 15, 20, 25, 30, 35, 40, 45, 50, 55, 60, 75, 80, 85, 90, 95, 100, or the like perforation apertures 160 and/or teeth 162 (or range between, overlap, and/or fall outside of any of these values). In some embodiments, as illustrated in FIGS. 4A through 4E, there may be more teeth 162 than perforation apertures 160, such as 2, 3, 4, 5, or the like times the number of teeth 162 than the number of perforation apertures 160. For example, as illustrated in FIG. 4A through 4C two teeth 162 are formed from each perforation aperture 160. However, it should be understood that any number of teeth 162 may be formed from each perforation aperture 160. Moreover, different types of perforation apertures 160 in a nailer plate 150 may form a different number of teeth 162 (e.g., depending on the location of the perforation aperture 160).

As illustrated, in FIGS. 4A through 4E, the perforation apertures 160 are illustrated as being rectangular in shape; however, it should be understood that the perforation apertures 160 may be triangular, trapezoidal, square, oval, circular, pentagonal, hexagonal, heptagonal, octagonal, any polygonal shape, uniform, non-uniform, or other like shape. Additionally, the perforation apertures 160 may be of any size. While the plurality of perforation apertures 160 are illustrated as being orientated in a generally horizontal orientation, the perforation apertures 160 may be in any orientation (e.g., vertical, diagonal, non-uniform, uniform, or the like). Additionally, as illustrated in FIGS. 4E, the rows and/or columns of perforation apertures 160 may or may not be offset from each other. For example, as illustrated in FIG. 4 alternating rows may be offset from each other, while each perforation aperture 160 in a column may be spaced equally. While FIG. 4 illustrates a particular pattern for the perforation apertures 160, it should be understood that the perforation apertures 160 may have any uniform and/or non-uniform pattern, which may or may not be offset. Moreover, different perforation apertures 160 in the same nailer plate 150 may have different shapes, sizes, orientations, or the like.

It should be also understood, like the perforation apertures 160, the plurality of teeth 162 (e.g., whether or not they are formed by the perforation apertures 160 or independent from perforation apertures 160) may be made of any shape, size, orientation, location, pattern, or the like. In some embodiments, the end of the teeth 162 formed from the perforation apertures 160 may have a point, may be rolled, folded, or the like (e.g., to increase the thickness, strength, or the like of the teeth 162), be twisted, and/or otherwise be shaped in order to aid in the installation of the nailer plate 160 (e.g., aid in allowing the teeth 160 to be pressed into the nailer member 100). As illustrated in FIGS. 4A through 4D, the teeth 162 may have a point, be rolled, and be twisted in order to aid in installing the teeth 162 in the nailer member 100.

While the first portion 152 of the nailer plate 150 may comprise the plurality of perforation apertures 160 and/or the plurality of teeth 162, the second portion 154 may be made of a solid material without apertures. However, in some embodiments the second portion 154 may have one or more apertures that may be utilized for plate connections 130 between the second portion 154 of the nailer plate 150 and the upper chord 20, as will be discussed in further detail herein.

The first portion 152 and the second portion 154 of the nailer plates 150 are illustrated as being rectangular in shape; however, it should be understood that the nailer plates 150, such as the first and second portions 152, 154 thereof, may be any size and shape, such as but not limited triangular, trapezoidal, square, oval, circular, pentagonal, hexagonal, heptagonal, octagonal, any polygonal shape, uniform, non-uniform, or other like shape. In some embodiments, the nailer plate 150 may have a width of 2, 3, 4, 5, 6, 7, 8, 9, 10, or the like inches, and a height (e.g., before bending) of 1, 2, 3, 4, 5, 6, or the like inches. Moreover, the height of the first portion 152 of the nailer plate may be 0.5, 1, 1.5, 2, 2.5, 3, 3.5, 4, or the like inches. It should be understood that the width and height of the nailer plate 150, and/or the height of the first portion 152 of the nailer plate 150 may have a range that falls within, overlaps, and/or falls outside of any of the values described herein.

In some embodiments, the nailer plate 150 may comprise a bend line 156, which may be embossed, indented, have one or more bend apertures, or the like features that aid in bending the nailer plate 150 during installation, as will be discussed in further detail herein. In some embodiments, the first portion 152 and/or the second portion 154 may comprise one or more ribs (not illustrated) which may provide additional strength to the nailer plate 150.

It should be understood that any number of nailer plates 150 may be utilized to operatively couple the upper chord 20 to the nailer member 100. For example, a single nailer plate 150 may be located on both sides of the upper chord 20 and the nailer mailer 100 (e.g., two nailer plates 150). Alternatively, multiple nailer plates 150 may be located on both sides of the upper chord 20 and the nailer member 100 (e.g., two or more nailer plates on each side). In other embodiments a single nailer plate 150 may have multiple cord plate portions 154 and/or multiple nailer plate portions 152, such that the nailer plate 150 may wrap around the top portion 102 and both sides 106, 107 of the nailer plate 150. As such, it should be understood that one or more nailer plates 150 may be used to operatively couple the nailer member 100 to the upper chord 20, and in some embodiments a plurality of nailer plates 150 may be used (e.g., two or more nailer plates 150). As such, depending on the length of the joist 10, the length of the upper chord 20, and/or the length of the one or more nailer members, the number of nailer plates 150 that are used may be 1, 2, 3, 4, 5, 6, 7, 8, 9, 10, 12, 14, 16, 18, 20, 22, 26, 28, 30, 40, 50, or the like nailer plates 150. Moreover, it should be understood that the number of nailer plates used may range between, overlap, or fall outside any number of nailer plates 150 discussed above.

Furthermore, it should be understood that one or more nailer members 100 may be used, such as a single nailer member 100 for the upper chord 20 or two or more nailer members 100 in series along the length of the upper chord 20. When two or more nailer members 100 are located in series, at least one nailer plate 150 may be located at the joint formed by the ends of two adjacent nailer members 150. Furthermore, it should be understood that in some embodiments, two or more nailer members may be stacked on top of each other. In this configuration, the nailer plates 150 (e.g., the nailer plate portion 152 thereof) may extend over at least a portion of the side surfaces 106, 107 of both nailer members 150.

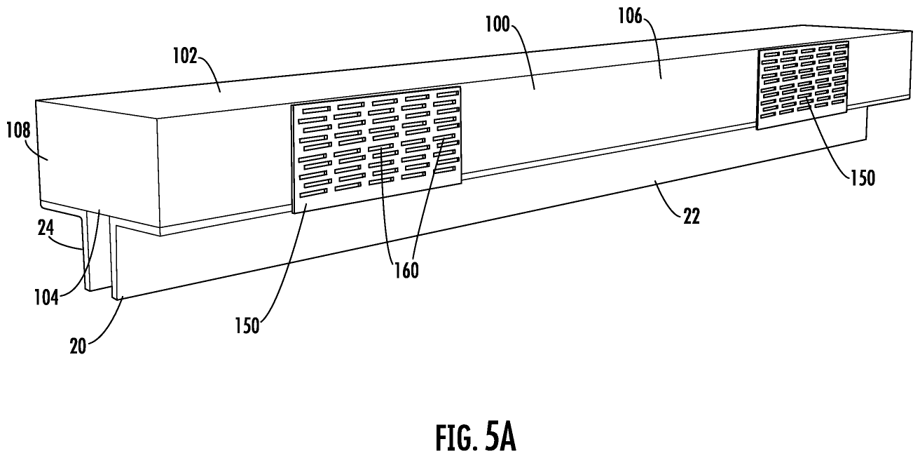

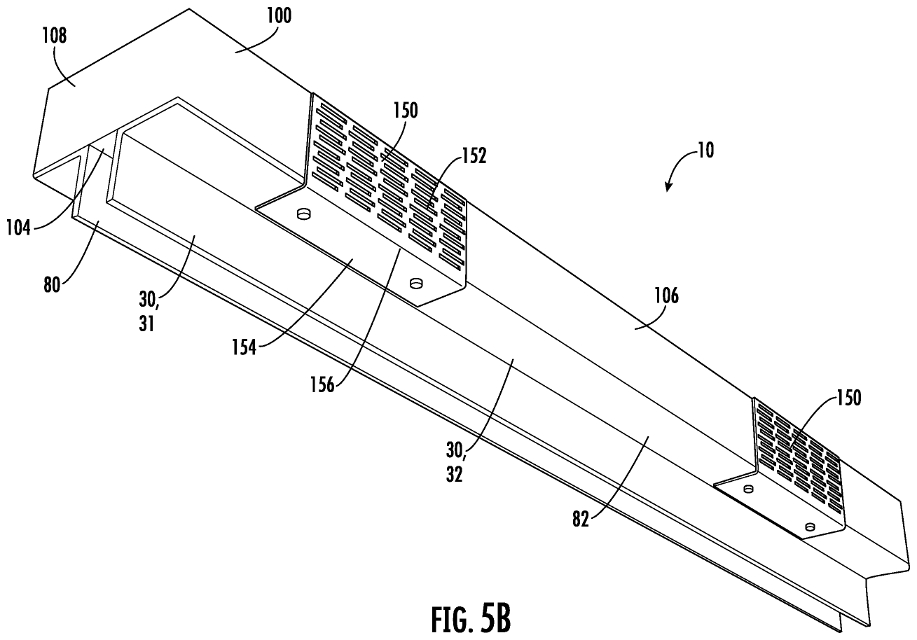

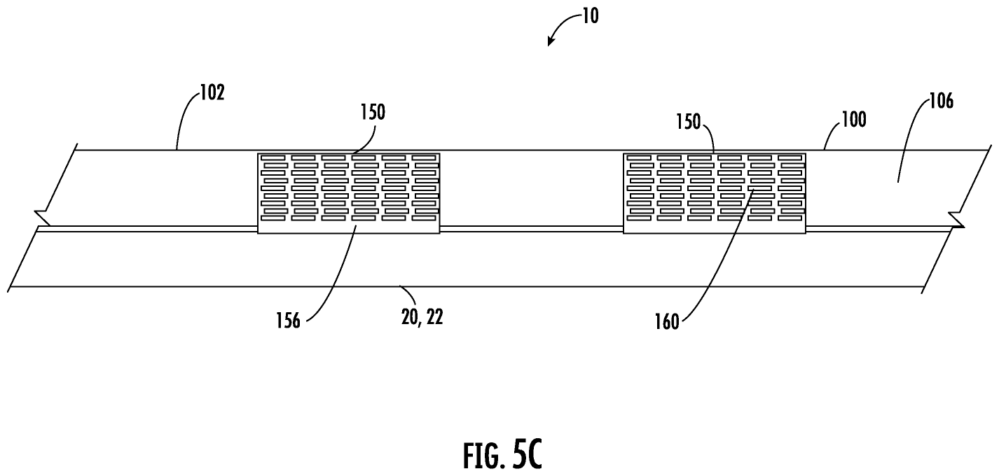

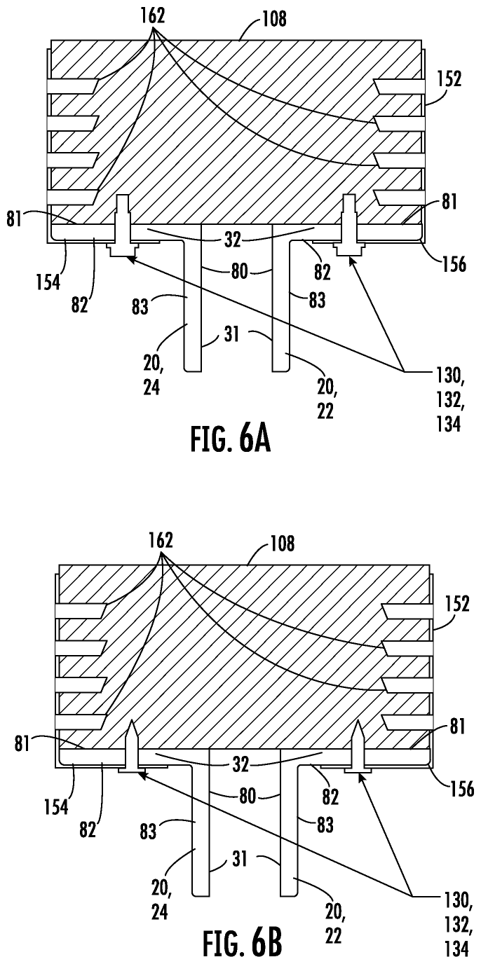

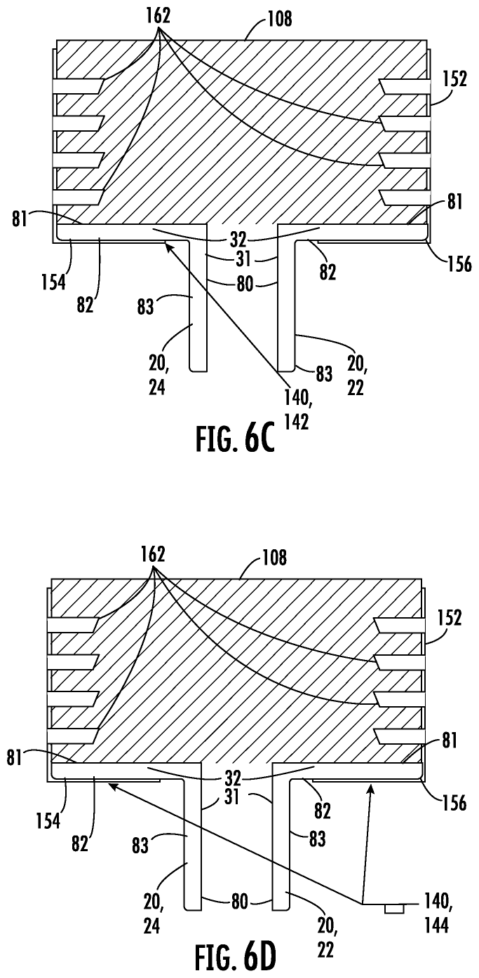

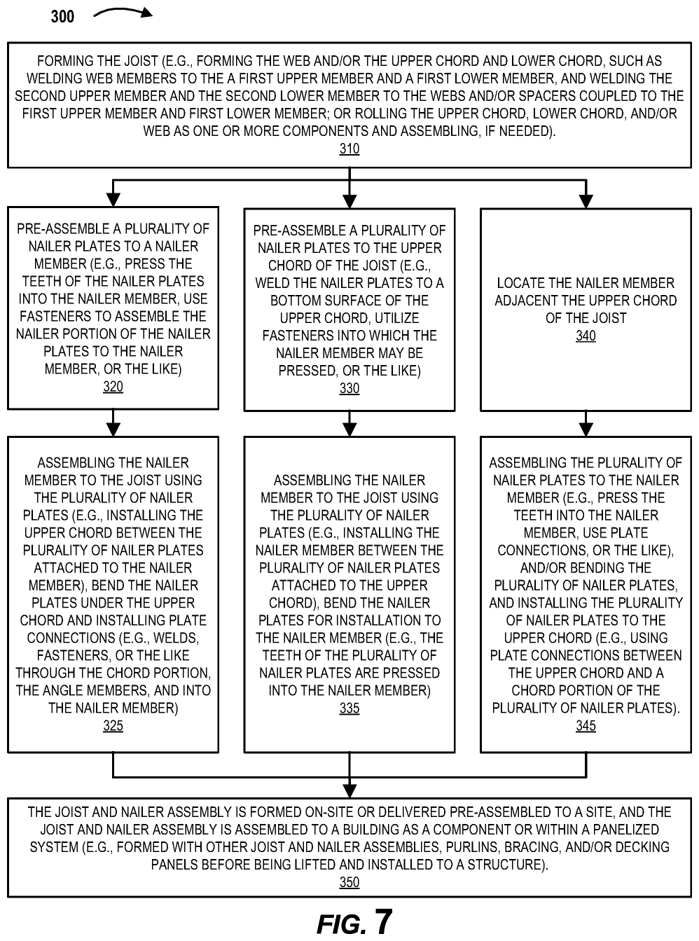

FIGS. 5A through 6D illustrate the nailer plate 150 operatively coupling the nailer member 100 to the upper chord 20. In particular, FIGS. 6A through 6D illustrate different connections 130 of the nailer plate 150 to the upper chord 20. For example, as illustrated in FIGS. 6A through 6D the teeth 162 in the first portion 152 of the nailer plate 150 may be pressed into a side 106, 107 of the nailer plate 150, as will be described in further detail with respect to the process described in FIG. 7. While the first portion 152 of the nailer plate 150 typically uses a plurality of teeth 162 for operative coupling with the nailer member 100, additionally, or alternatively, plate connections 130 (e.g., fasteners, or the like) may be used to operatively couple the first portion 152 of the nailer plate 150 to the nailer member 100.

Alternatively, the second portion 154 of the nailer plate 150 may be operatively coupled to a surface of the upper chord 20, such as to a bottom surface of the upper chord 20. It should be understood that the bottom surface may be any surface of a portion of the upper chord that is located below a top surface to which the nailer member 100 is operatively coupled. In the illustrated embodiments, the bottom surface to which the second portion 154 of the nailer plate 150 is operatively coupled is the bottom surface 82 of the distal arms 32 of the first upper member 22 or a second upper member 24 of the upper chord 20. The second portion 154 of the nailer plate 150 may be operatively coupled to the upper chord 20 through the use of one or more plate connections 130 (e.g., fasteners 132, such as nails, screws, bolts, pins, nuts, or the like, clamps, other plates, welds, or the like). For example, as illustrated in FIG. 6A, one or more fasteners 132, such as self-drilling screws 134 may be screwed through the second portion 154 of the nailer plate 150 through the upper chord 20, such as a distal arm 32 of a first upper member 22 or a second upper member 24, and into a lower surface 104 and core of the nailer member 100. In other examples, as illustrated in FIG. 6B, other types of fasteners 132, such as pins 136 (e.g., powder driven pins, pneumatic driven pins, or the like) may be shot through the second portion 154 of the nailer plate 150 through the upper chord 20, such as a distal arm 32 of a first upper member 22 or a second upper member 24, and into a lower surface 104 and core of the nailer member 100.

In other examples, as illustrated in FIG. 6C, one or more welds 140, such a toe weld 142 may be used between the toe of the second portion 154 of the nailer plate 150 and a surface of the upper chord 20, such as the bottom surface 82 of the distal arm 32 of a first upper member 22 or a second upper member 24. In other examples, as illustrated in FIG. 6D, one or more welds 140, such spot welds 144 or puddle welds 144 (e.g., otherwise described as a plug weld, or the like) may be used between the second portion 154 of the nailer plate 150 and the upper chord 20, such as at a bottom surface 82 of a distal arm 32 of a first upper member 22 or a second upper member 24. It should be understood that the welds may have a length or diameter (e.g., depending on the type of weld being a toe weld, a spot weld, a puddle weld, and/or other like weld) of 1/16, ⅛, ¼, 5/16, ⅜, 7/16, ½, 9/16, ⅝, 11/16, ¾, 1, 1¼, 1½, 1¾, 2, 2½, 3, 3½, 4, 4½, 5, 6, 7, 8 or the like inches. It should be understood that the welds may have a length or diameter that falls within, overlaps, and/or falls outside of any of the foregoing values.

It should be understood that the nailer plate 150, such as the toe of the second portion 154 of the nailer plate 150 may extend to a location adjacent the proximal arm 31 of the first member 22 or second member 24 of the upper chord 20. As such, the welds may include welding a portion of the toe of the second portion 154 to an outer surface 83 of the proximal arm 31 and/or bottom surface 82 of the distal arm 32 of the first member 22 or the second member 24 of the upper chord 20.

It should be further understood that while the nailer plate 150 is illustrated as having only a first portion 152 and a second portion 154, it should be understood that the nailer plate 150 may include one or more other portions. The one or more other portions may extend around a top surface 102 of the nailer member 100, adjacent the proximal arm 31 of the first member 22 or second member 24, or extend around another portion of a chord (e.g., different type of chord having one or more members of a different shape, or the like). As such, additionally or alternatively, in some embodiments the plurality of apertures 160 and/or a plurality of teeth 162 may be located in the nailer plate portion that extends around the top surface 102 of the nailer member 100. Furthermore, it should be understood that while the second portion 154 is illustrated as being operatively coupled to the bottom surface 82 of the distal arm 32, it may be operatively coupled to other surfaces of an upper chord 20. For example, the first portion 152 and the second portion 154 may be located in the same plane and operatively coupled to an upper chord portion that is located in the same plane as one of the side surfaces 106, 107 of the nailer member 100. For example, to a side of an upper chord 20 the same as or similar to the upper chord 20 of the joist illustrated in FIG. 3D. In other embodiments, the second portion 154 may be located at an angle with respect to the first portion 152. In still other embodiments, the second portion 154 may have multiple bends at various angles in order to be operatively coupled to upper chords 20 having different surfaces.

FIG. 7 illustrates a process flow 300 for assembling the joist and nailer assembly 10, in particular, for assembling the upper chord 20 of the joist (e.g., assembled steel joist, or the like) and the nailer member 100 (e.g., wood nailer, or the like) using a plurality of nailer plates 150. Block 310 of FIG. 7 illustrates that the joist is formed manually, automatically, or a combination thereof. For example, with respect to open web joists, the web members 62 are operatively coupled to the upper chord 20 and/or the lower chord 40 through the use of web connections (e.g., fasteners, welds, or the like). In some embodiments, the ends of the web members 66 are welded to a first upper member 22 of the upper chord 20 and a first lower member 42 of the lower chord 40 on a rigging table (e.g., within a jig by manual welding or automated welding). At the same time, or at a time thereafter, the second upper member 24 of the upper chord 20 and the second lower member 44 of the lower chord 40 are welded to the web members 66 and/or spacers operatively coupled first upper member 22 and/or first lower member 24 (e.g., spacers welded or otherwise fastened to the members).

It should be understood that other joists having other types of upper chords and lower chords may be formed in different ways, such as by rolling or bending sheets into the upper and lower chords and/or web as a single member or as multiple members (e.g., that are thereafter assembled together), as illustrated by FIG. 3D. In other embodiments, the upper and lower chords may be formed as one or more different members having shapes different than the angle members illustrated in figures of the present disclosure. Moreover, the web 60 may be operatively coupled to the upper chord 20 and/or the lower chord 40 through the use of fasteners, or the like.

After the joist is formed, a plurality of nailer plates 150 may be operatively coupled to the upper chord 20 and/or the nailer member 100 in order to operatively couple the nailer member 100 to the upper chord 20. As illustrated by block 320 in FIG. 7, the plurality of nailer plates 150 may be pre-assembled to the nailer member 100. For example, the plurality of teeth 162 of the first portion 152 of the nailer plates 150 may be pressed into a first side surface 106 or a second side surface 107 of the nailer member 100. The teeth 162 may be pressed manually into the nailer member 100 (e.g., by a user pressing, hammering, or the like the nailer plate 150 into the nailer member 100). Alternatively, the teeth 162 of the nailer plates 150 may be automatically located adjacent the nailer member 100 and automatically pressed into the nailer member 100 (e.g., using rollers, actuating arms, rams, or the like). While the nailer plate 150 may be operatively coupled to the nailer member 100 using a plurality of teeth 162, additionally, or alternatively, the first portion 152 of the nailer plate 150 may be operatively coupled to the nailer member 100 (e.g., automatically, manually, or the like) using plate connections 130.

As illustrated by block 325 of FIG. 7, when the nailer plates 150 are pre-assembled to the nailer member 100, the nailer member 100 with the pre-assembled plates 150 may be assembled to the joist in order to form the joist and nailer assembly 10 described herein. For example, the upper chord 20 may be placed on top of the nailer member 100 (e.g., in an upside-down orientation, or the like) between the second portions 154 of the plurality of nailer plates 150 on either side of the nailer member 100. The assembly process may utilize the weight of the joist to hold the nailer member 100 in place for assembly with the upper chord 20 and/or use mechanical fasteners (e.g., claims, jigs, or the like) and/or automated components (e.g., robots) to hold the joist in place. The second portion 154 of the nailer plates 150 may be bent (e.g., manually or automatically) around a portion of the upper chord 20 (e.g., a surface, such as a bottom surface 82 of the distal arm 32, or the like). For example, the nailer plates 150 may be bent around the distal arms 32 of the first upper member 22 or the second upper member 24. In some embodiments, as previously discussed herein, the second portion 154 of the nailer plates 150 may be automatically bent around the distal arm 32 using rollers, actuator arms, rams, or the like. Moreover, in this configuration, having the second portion 154 of the nailer plate 150 and the bottom surface 82 of the chord member 20 exposed allows for the nailer couplings 130 to be installed. For example, this position aids in allowing a user to manually install a fastener 132 or to manually form a weld 140 from above. Alternatively, this position may allow for an automated process (e.g., automated robot) to install a fastener 132 or to make a weld 140 from above. However, it should be understood that the nailer connections 130 may be installed in any orientation (e.g., from the side, from below, or the like).

Block 330 of FIG. 7 illustrates that in alternate processes, the nailer plates 150 may be pre-assembled to the upper chord 20 of the joist. For example, in some embodiments, the second portion 154 of the nailer plate 150 may be assembled to a surface of the upper chord 20, such as the bottom surface 82 of a distal arm 32 of the first upper member 22 or the second upper member 24. As previously discussed, the second portion 154 may be assembled to the distal arm 32 through the use of fasteners 132 (e.g., pins onto which the nailer member 100 may be later pressed onto, or the like), or more likely welds 140 (e.g., toe weld 142, spot or puddle weld 144), as previously discussed herein. In some embodiment, the second portion 154 of the nailer plate 150 may be manually pre-assembled; however, in other embodiments the second portion 154 of the nailer plate 150 may be automatically installed through the use of automated robots. The nailer plates 150 may be installed in any orientation; however, in some embodiments the nailer plates 150 may be installed when the joist is upside-down (e.g., with respect to its installed position in a structure) in order to provide improved access to a surface (e.g., the bottom surface 82, or the like) of the upper chord 20.

As illustrated in block 335, the nailer member 100 may be installed to the joist in order to form the nailer joist 10 by installing the nailer member 100 between the plurality of nailer plates 150. Thereafter, the nailer plates 150 are bent such that the teeth 162 of the first portion 152 of the nailer plates 150 are pressed into a side surface 106, 107 (or a top surface 102 in other embodiments) of the nailer member 100. In some embodiment, the first portion 152 of the one or more nailer plates 150 may be bent manually; however, in other embodiments the first portion 152 of the one or more nailer plates 150 may be automatically bent and pressed into the nailer member 100 (e.g., using rollers, actuator arm, ram, or the like). The joist may be located in any orientation when the first portion 152 is pressed into the nailer member 100. Alternatively, or additionally, plate connections 130 may be utilized to operatively couple the first portion 152 of the nailer plate 150 to the nailer member 100, such as fasteners 130 as previously described herein.

In some embodiments the nailer plate 150 may not be pre-assembled to the nailer member 100 and/or the upper chord 20 of the joist. Instead, as illustrated in block 340 of FIG. 7, the nailer member 100 may be located adjacent the upper chord 20 of the joist, and the nailer plate 150 may be assembled to the nailer member 100 and the upper chord 20 at the same or similar time. In some embodiments, the nailer plates 150 may be at least partially pre-bent to aid in the assembly process. However, in other embodiments the nailer plates 150 may not be bent before being installed. As illustrated in block 345, in some embodiments, the first portion 152 of the nailer plates 150 may be installed to the nailer member 100 (e.g., pressed into, assembled using plate connections 130, or the like); however, in other embodiments the second portion of the nailer plates 150 may be installed to upper chord 20, as previously discussed herein. Moreover, as previously discussed herein the nailer plate 150 may be assembled manually, automatically, or a combination thereof. Once the first portion 152 and/or the second portion 154 is assembled, as discussed herein, the joist and nailer assembly 10 may be shipped and/or assembled to a structure.

As illustrated by block 350 of FIG. 7, the nailer joist 10 is assembled at the manufacturing facility before, during, or after assembling the chords 20, 40 and web 60 to form the open web joist and nailer assembly 10. The assembled joist and nailer assembly 10 may be delivered (e.g., shipped, or the like) pre-assembled; however, in some embodiments the nailer member 100 may be assembled to the joist on the job site. In some embodiments, the open web joist and nailer assembly 10 may be assembled in a structure as a single component; however, in other embodiments the nailer joist 10 may be operatively coupled to other joist and nailer assemblies 10, bridging 190, and/or panels 90 to form a panelized section before being assembled to a structure.

The use of the nailer plate 150 in the joist and nailer assembly 10 provides advantages over traditional systems in which fasteners are used to assemble the upper chord to a wood member. The connection between the wooden nailer member and the upper chord of the joist must be secure in order to provide lateral stability to the upper chord of the joists, resistance to and the transfer of axial forces for uplift resistance, and/or the transfer of the axial forces for the wooden nailer member to the upper chord. In order to provide these functions, traditional systems required the use of pre-drilled apertures in the upper chord, and the use of many fasteners in order to provide the desired load transfer and resistance. However, the nailer plate 150 of the present disclosure allows the nailer member 100 to be operatively coupled to upper chord 20 with a reduced number of connections (e.g., fasteners, welds, or the like), which reduces the assembly time, labor costs, or the like associated with the assembling joists to nailer members.

It should be understood that “operatively coupled,” when used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together.

Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more.”

Certain terminology is used herein for convenience only and is not to be taken as limiting unless such terminology is specifically described herein for specific embodiments. For example, words such as “top”, “bottom”, “upper”, “lower”, “below”, “above”, “vertical”, “horizontal”, or the like may merely describe the configurations shown in the figures and described herein for some embodiments of the invention. Indeed, the components may be oriented in any direction and the terminology, therefore, should be understood as encompassing such variations unless specified otherwise. The terminology includes the words specifically mentioned above, derivatives thereof and words of similar import.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A joist and nailer assembly, comprising:
an upper chord;
a lower chord;
a web operatively coupling the upper chord and the lower chord;
a nailer member; and
a plurality of nailer plates operatively coupling the nailer member to the upper chord using plate connections;
wherein the plurality of nailer plates extend around a portion of the upper chord and a side of the nailer member.

2. The joist and nailer assembly of claim 1, wherein the upper chord comprises:
a first upper member; and
a second upper member operatively coupled to the first upper member.

3. The joist and nailer assembly of claim 2, wherein the first upper member is operatively coupled to the second upper member through the web or a spacer.

4. The joist and nailer assembly of claim 1, wherein the lower chord comprises:
a first lower member; and
a second lower member operatively coupled to the first lower member.

5. The joist and nailer assembly of claim 4, wherein the first lower member is operatively coupled to the second lower member through the web or a spacer.

6. The joist and nailer assembly of claim 1, wherein the upper chord, the lower chord, or the web are formed from angle members.

7. The joist and nailer assembly of claim 1, wherein the plurality of nailer plates comprise:
a nailer portion having a plurality of teeth, wherein when assembled the plurality of teeth extend into the nailer member.

8. The joist and nailer assembly of claim 7, wherein the nailer portion comprises a plurality of perforated apertures that form the plurality of teeth.

9. The joist and nailer assembly of claim 7, wherein the plurality of nailer plates comprise:
a chord portion, wherein when assembled the chord portion extends around a surface of the upper chord.

10. The joist and nailer assembly of claim 9, wherein the chord portion is operatively coupled to the surface of the upper chord through one or more plate connections.

11. The joist and nailer assembly of claim 10, wherein the one or more plate connections comprise fasteners.

12. The joist and nailer assembly of claim 11, wherein the fasteners are self-drilling screws or powder pins.

13. The joist and nailer assembly of claim 10, wherein the one or more plate connections comprise a weld.

14. The joist and nailer assembly of claim 13, wherein the weld is a toe weld on a toe of the chord portion of a nailer plate.

15. The joist and nailer assembly of claim 13, wherein the weld is a puddle weld or a spot weld within the chord portion of a nailer plate.

16. The joist and nailer assembly of claim 1, wherein the nailer member is wood.

17. A nailer plate for use within a joist and nailer assembly, wherein the nailer plate comprises:
a nailer portion having a plurality of teeth; and
a chord portion;
wherein when assembled the plurality of teeth extend into a nailer member of the joist and nailer assembly; and
wherein when assembled the chord portion extends around a surface of an upper chord of the joist and nailer assembly.

18. The nailer plate of claim 17, wherein the nailer portion comprises a plurality of perforated apertures that form the plurality of teeth.

19. A method of forming a joist and nailer assembly, the method comprising:
assembling a plurality of nailer plates to a nailer member or an upper chord of a joist, wherein the plurality of nailer plates comprise a nailer portion having a plurality of teeth and a chord portion;
when the plurality of nailer plates are first assembled to the upper chord of the joist, bending the nailer portion to press the plurality of teeth into the nailer member; and
when the plurality of nailer plates are first assembled to the nailer member, bending the chord portion to a surface of the upper chord and operatively coupling the chord portion to the upper chord using plate connections.

20. The method of claim 19, wherein the bending is automated through the use of a bending means.
